(19) United States
(12) Patent Application Publication
(10) Pub. No.: US 2010/0062808 A1
(43) Pub. Date: Mar. 11, 2010

(54) UNIVERSAL INTEGRATED CIRCUIT CARD HAVING A VIRTUAL SUBSCRIBER IDENTITY MODULE FUNCTIONALITY

(75) Inventors: Inhyok Cha, Yardley, PA (US); Andreas U. Schmidt, Frankfurt am Main (DE); Yogendra C. Shah, Exton, PA (US); Michael V. Meyerstein, Ipswich (GB)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL PATENT HOLDINGS, INC., Wilmington, DE (US)

(21) Appl. No.: 12/546,827

(22) Filed: Aug. 25, 2009

Related U.S. Application Data
(60) Provisional application No. 61/091,602, filed on Aug. 25, 2008.

(51) Int. Cl. H04B 1/38; G06F 21/00

(52) U.S. Cl. 455/558; 726/22

(57) ABSTRACT

Universal integrated circuit card (UICC) having a virtual subscriber identity module functionality is disclosed. A wireless transmit/receive unit (WTRU) comprises a mobile equipment (ME) configured to perform wireless communication and a UICC. The UICC is configured to perform security functionalities. The UICC supports multiple isolated domains including UICC issuer's domain. Each domain is owned by a separate owner so that each owner stores and executes an application on the UICC under a control of an UICC issuer and the UICC issuer's domain controls creation and deletion of other domains and defines and enforces security rules for authorizing third parties to have an access to the domains. The UICC is configured to verify integrity of operating system functions and applications stored on the UICC. The UICC is configured to control an access to information regarding applications according to security policies stored within the UICC.

### CROSS REFERENCE TO RELATED APPLICATIONS

This application claims the benefit of U.S. provisional application No. 61/091,602 filed Aug. 25, 2008, which is incorporated by reference as if fully set forth.

### FIELD OF INVENTION

This application is related to wireless communications.

### BACKGROUND

Wireless communications systems have long relied on the smart card (subscriber identity module (SIM) card) to provide a center for security functionality in wireless devices. In recent years this has evolved into the universal integrated circuit card (UICC). The UICC is considered a secure, multi-application environment from which to execute the various security algorithms, such as authentication key agreement (AKA) authentication algorithm used in third generation (3G) networks in a secure, tamper-resistant manner. These algorithms and others constituting device identities or user identities are typically embodied in the universal subscriber identity module (USIM) and IMS subscriber identity module (ISIM) applications which are hosted by the UICC. The UICC is a plug-in module which is typically hosted by the wireless device.

With the growing number of wireless communication devices, there is a need to provide a more dynamic solution to the current SIM functions carried out within a SIM card or a UICC to overcome some shortcomings in relation to modern and evolving mobile communication networks. The UICC provides a secure execution and storage environment from which to execute the SIM authentication algorithms and store credentials. However, the cost of the UICCs, their impractical form factor, and limited functionality prevent them from being used in applications where the mobile network operator may only be known some time after the purchase of the wireless device. Alternatively, the UICC fails when multiple operator networks are to be supported or accessed simultaneously within one device. Methods to update or change mobile network and service subscriptions are limited with SIM cards, and are generally lacking, when over-the-air deployment is desirable.

Furthermore, even though the SIM card or the UICC is generally considered to be highly secure, this security is not linked strongly to security properties of the whole device on which it resides. This limits the application of scaling security concepts for advanced services and applications such as mobile financial transactions. All of these problems are imminent for autonomous devices connected to mobile networks for instance in machine-to-machine (M2M) communication.

Accordingly, a more dynamic and concurrently secure solution to the SIM function is needed.

### SUMMARY

File contents and security-sensitive components of the USIM and ISIM applications, including keys and algorithm customization parameters, may be securely downloaded to the UICC, transparently through a mobile equipment (ME), from a remote server across untrusted public networks. The UICC provides an environment that supports separate domains for UICC card issuer and other third parties such as mobile network operators, that isolates downloaded applications including sensitive data such as encryption keys from each other. The UICC card issuer may administer the third-party domains but cannot see the applications or their content (such as keys) therein, that third parties may securely download and manage applications to/in their domains. The owner of the top-level domain (normally the UICC card issuer) may be a party other than the mobile network operator to whose network the communications device is usually connected when in its normal environment (e.g., the owner of the top-level domain may be the machine-to-machine equipment provider).

The UICC may control the lifecycle status of the downloaded applications that it supports. The UICC may enable authorized parties to remotely discover the existence and lifecycle status of applications on the UICC. The UICC may verify the integrity of its own systems and of the applications that it supports and report the status to an external entity and take appropriate action where the integrity checks detect a problem.

### BRIEF DESCRIPTION OF THE DRAWINGS

A more detailed understanding may be had from the following description, given by way of example in conjunction with the accompanying drawings wherein:

FIG. 1 is a block diagram of an example WTRU;

FIG. 2 shows an example procedure for building a trusted subsystem (TSS) for an MNO (TSS-MNO) on the UICC; and

FIG. 3 shows an example procedure for migration of SIM credentials and its execution environment from one UICC to another.

### DETAILED DESCRIPTION

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment.

In accordance with embodiments disclosed herein, a hardware anchored root of trust for security, a secure boot operation, and attestation are combined to provide an environment to realize the secure implementation of a virtual SIM application with the UICC. An intermediate form of security may also be realized through substitution of the attestation for authentication whereby a successful integrity check is factored into the authentication response of an authentication protocol. Besides the checks necessary for authentication an additional integrity check of the device operating system and/or applications is also performed and if the authentication itself is successful then the integrity check must also be successful to send a positive authentication response.

A virtual SIM application is hosted by the UICC. The requirement for secure boot including the full downloaded applications may be further simplified when only secure applications are being downloaded from secure trusted authorities.

Many of the security features of a UICC are utilized to simplify the procedures. For example, the notion of a trusted component such as a mobile trusted module (MTM) may be realized within a UICC when only trusted applications are executed within the UICC. The UICC also inherently provides an implied trusted engine environment within which different stake holder engines may be created.

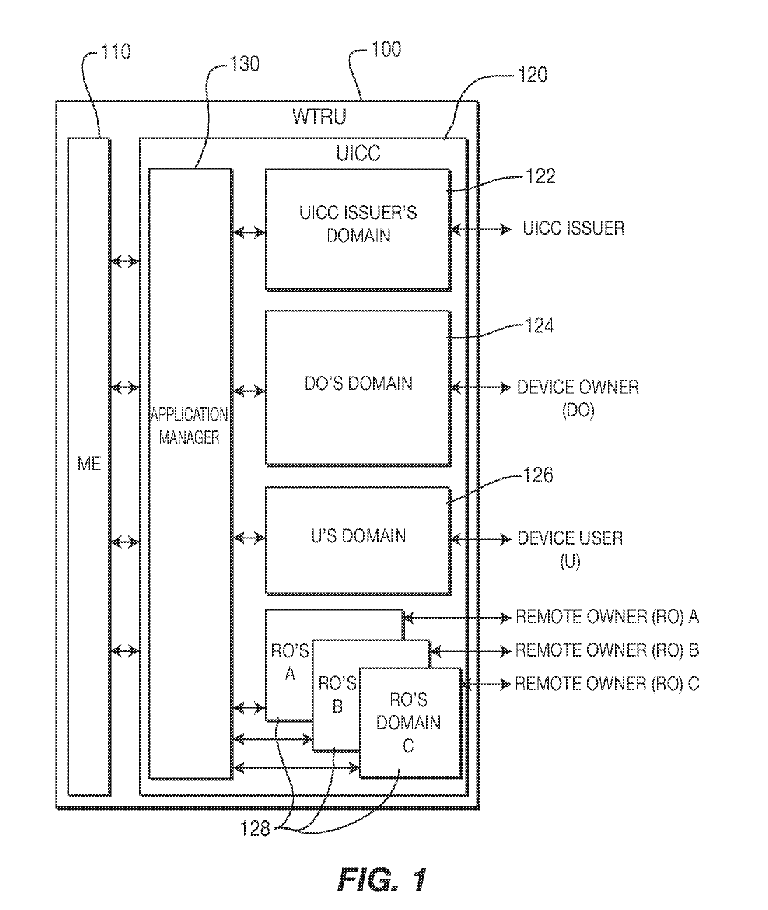

FIG. 1 is a block diagram of an example WTRU 100. The WTRU 100 includes a mobile equipment (ME) 110 and a UICC 120. The ME 110 provides modems, radios, power control components, and the like (not shown) for wireless communications, as typically provided by mobile handsets or terminals. The UICC 120 is a removable card installed on the WTRU 100. The UICC 120 includes a processing unit and a memory, etc. for running SIM, USIM, ISIM or any other applications. The UICC 120 may also provide storage for data and other applications.

In accordance with one embodiment, the UICC 120 is configured to verify the integrity of at least some specified secure functions within its operating system and of applications stored on the UICC 120. The integrity check of the secure operating system functions of the UICC 120 may be executed every time the UICC 120 is reset (warm or cold reset) or powered up from a switched-off or dormant state. An integrity check of the applications stored in the UICC 120 may be executed every time a system-level integrity check is performed and also when an application in a security domain is selected for use, (i.e., the integrity of the installed application is verified). Alternatively, in cases where applications are downloaded only from secure trustworthy authorities, the UICC may perform an integrity check of the downloaded application package(s) upon receipt and thereafter an external entity may assume that the UICC 120 operates only trusted application functions and the integrity check may be omitted once installed. If the integrity check passes, the UICC 120 may send an appropriate status message to an external entity or continue its normal operation. If the integrity check fails, the UICC 120 may shut itself down, or permanently or temporarily disable an application(s).

The UICC 120 is logically divided into separate security domains. In the example shown in FIG. 1, the UICC 120 is logically divided into a UICC issuer domain 122, a device owner's (DO's) domain 124, a device user's (U's) domain 126, and a plurality of remote owner's (RO's) domains 128. It should be noted that the number of domains in FIG. 1 is an example and the UICC 120 may be divided into more or less domains. Separate security domains are provided to permit the device owner/user or third parties to store and execute their applications on the UICC 120 in a secure manner and under the overall control of the UICC issuer, and to permit the UICC issuer to exercise control over how the UICC 120 is used and by whom.

The security domains are organized as a hierarchy with a UICC issuer domain 122 at the top level of the hierarchy and subordinate domains beneath the UICC issuer domain 122. The UICC issuer is the party that has overall control of the UICC functions and data before the UICC 120 is released into a productive environment, (e.g., a device integration facility). In particular, the UICC issuer may be a UICC manufacturer or subordinate company, or a communications carrier/operator who has legal ownership of the UICC 120 and issues it to end customers after receiving it from a manufacturer. The UICC issuer controls the UICC issuer domain 122. The UICC issuer domain 122 provides security-related administrative functions for the UICC issuer. For example, the UICC issuer domain 122 controls creation and deletion of subordinate domains and defines and enforces the security rules for authorizing third parties to have an access to the subordinate domains.

Subordinate domains (i.e., RO's domains 128) may be allocated to specific third-party entities, (e.g., mobile network operator (MNO)), who may be permitted to place their own applications on the UICC 120, subject to satisfying the relevant secure access conditions. Access to the domains by the third parties may require authentication of the third party to the UICC 120 and may also require authentication of the UICC 120 to the third party. The device owner and the user may be the same and only one domain may be established for the device owner/user.

The UICC 120 provides isolation of the security domains, such that the owners of subordinate domains may be prevented from accessing the contents of other domains at the same level or at different levels in the hierarchy in an unauthorized manner and the owner of the top or upper-level domain may not be allowed to discover or modify the contents of a subordinate domain that has been allocated to a third party. Within a single subordinate domain and between separate subordinate domains, the UICC 120 prevents installed applications from interacting with each other in an unauthorized manner. Applications within the same subordinate domain and within different subordinate domains may be permitted to interact with each other but only where allowed by the security policies associated with each application and only in ways which are specifically permitted by the security policies.

The UICC 120 includes an application management entity 130. The application management entity 130 manages the downloading process, manages installation, updating and deletion of applications, moves applications through their lifecycle stages according to instructions from authorized external entities or from functions within the UICC 120 such as the integrity check function, and maintains a registry of applications and their current lifecycle stages. The application management entity 130 may be installed in the UICC 120 as part of the UICC manufacturing process in a physically secure facility together with appropriate credentials associated with each specific UICC 120.

A remote entity, (e.g., a UICC issuer, an owner/subscriber, or a download service provider), may query the UICC 120 to discover the presence and lifecycle status of applications. This function may require the querying entity to authenticate itself to the UICC 120 and may also require the UICC 120 to authenticate itself to the querying entity.

Conventionally, the only information about the stored applications in the UICC 120 available to external entities is the presence of the application, as identified by an application identifier (AID) stored in a directory. That directory file does not include information about the lifecycle status of the applications. In addition, there is no security control applied to reading the AIDs in the directory file in prior art. In accordance with one embodiment, an access to information regarding applications may be restricted by the UICC 120 according to security policies stored within the UICC 120. Such policies may be global to the UICC 120 or may be application-specific.

Before a stakeholder (such as the MNO) can install an application in the UICC 120, the stakeholder must take possession of the UICC 120 in order to prepare for, and install, the application. This process creates a stakeholder engine within the UICC 120, (i.e., trusted subsystem (TSS) for the stakeholder). The UICC 120 supports protocols that enable the exchange of credentials so that the remote stakeholder may verify the state of the UICC 120 and setup credentials in the UICC 120 in preparation for provisioning of the application.

It is necessary for the UICC 120 and the WTRU 100 to gain temporary access to a communication network for downloading the application(s) that are required for operational access to communication networks and subsystems. This temporary access may require an application on the UICC 120 that is capable of providing an authentication service to a network operator who will grant a temporary access to the network. In accordance with one embodiment, this application is provisioned onto the UICC 120 at the time of its manufacture. The credentials in the application may be issued by an authority that is recognized by the temporary network operator but who might not be the UICC issuer, in which case the authentication of the UICC 120 requires reference to the authority that provided the credentials.

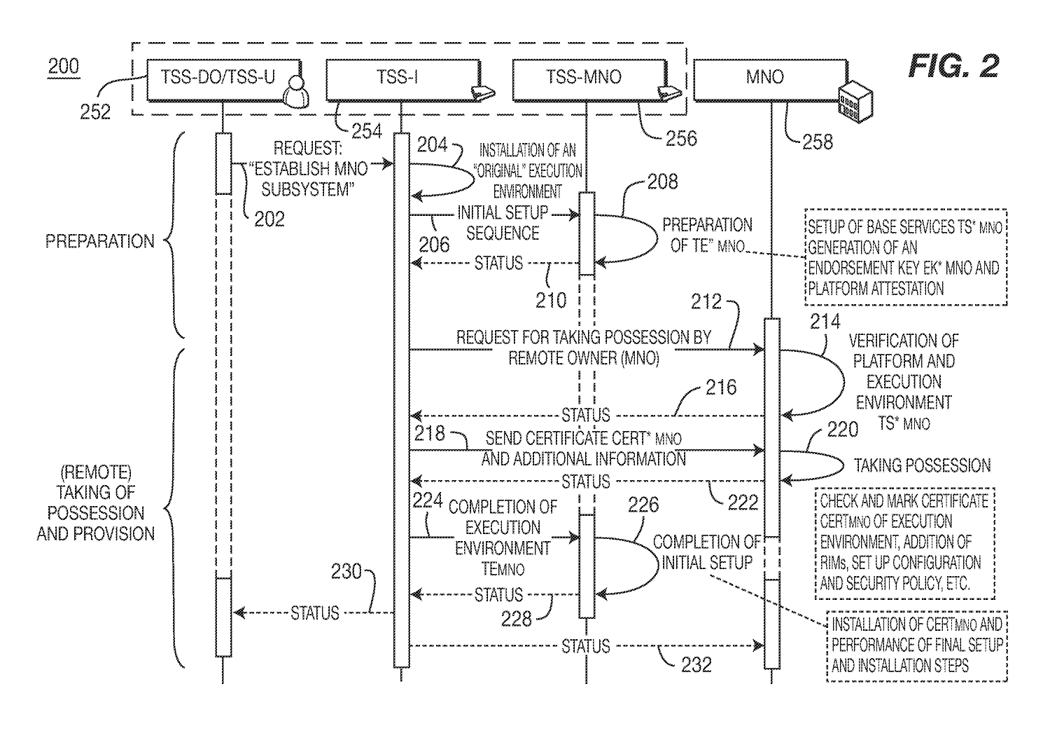

FIG. 2 shows an example procedure 200 for building a trusted subsystem (TSS) for an MNO (TSS-MNO 256) on the UICC 120. The UICC 120 currently has the TSS for the UICC issuer (TSS-I 254) and the TSS for the device owner/user (TSS-DO/TSS-U 252). The TSS-DO/TSS-U 252 is in communication with an MNO 258. It should be noted that the term “TSS-MNO” is used to refer to both the trusted subsystem established by this procedure 200 and also the trusted execution environment (TE) for the MNO (TE-MNO) which will become the TSS-MNO at the end of the procedure 200. The taking of possession by a remote owner, (i.e., the MNO 258 in this example), establishes the fundamental and elementary relationship of trust between the remote owner and the UICC 120. The procedure 200 requires that an empty or pristine execution environment exist. The first part of the procedure 200 is preparing an empty execution environment, while the second part is remotely taking ownership of the newly created TE. The pristine TSS-MNO comprises a pristine standard execution environment having a base functionality and/or a number of trusted services. When the pristine TSS-MNO provides the MNO with proof of its untouched configuration, structure, and conformity regarding its security policy, it is certified by the MNO 258.

The procedure begins when the TSS-DO/TSS-U 252 sends a request to establish a TSS-MNO to the TSS-I 254 (step 202). The TSS-I 254 then installs an original execution environment TE-MNO (step 204). The TSS-I 254 then sends an initial set up sequence to the newly created TE-MNO (step 206). An “empty” execution environment is then established, and a new entity (i.e., TSS-MNO 256) of the security module is activated or created (step 208). The TSS-MNO 256 sends a status message back to the TSS-I 254 (step 210).

The remote take ownership part of the procedure 200 begins when the TSS-I 254 sends a request for taking possession to the MNO 258 (step 212). The MNO 258 performs verification of the trusted mobile platform and the execution environment TSS-MNO 256 (step 214). The MNO 258 then sends a status message to the TSS-I 254 (step 216). The TSS-I 254 then sends a certificate and additional information to the MNO 258 (step 218). The MNO 258 checks and signs the certificate and sets up a configuration and security policy (step 220). The MNO 258 sends a status message to the TSS-I 254 (step 222). The TSS-I 254 sends a completion of execution environment TE-MNO to the TSS-MNO 256 (step 224). The TSS-MNO 256 then completes the initial set up by installing the certificate and performing a final set up and installation procedure (step 226). The TSS-MNO 256 then sends a status message back to the TSS-I 254 (step 228). The TSS-I 254 forwards a status message to the TSS-DO/TSS-U 252 (step 230). The TSS-I 254 also sends a status message to the MNO 258 (step 232).

A procedure for downloading security-sensitive applications and installing the applications is explained hereafter. In order for the UICC 120 to participate in the process of accessing communications networks and sub-systems within those networks, the UICC 120 is required to support appropriate applications. In accordance with one embodiment, the required applications may be provisioned to the UICC 120 by downloading them via the ME 110 from a remote server over an insecure public network. Applications to be downloaded in this manner comprise a package that may include security-sensitive objects which may include, but are not limited to, encryption keys, algorithm customization parameters, user identities, executable encryption algorithms, executable commands and responses, file systems, security policies, or the like.

The UICC 120 supports a protocol or suite of protocols that ensure security of the application downloading process end-to-end between the UICC 120 and the remote server. Such protocols may require involvement of the host terminal to manage the protocol interactions between the UICC 120 and the remote server. Conventionally, such protocols are conveyed to the UICC in messages that are specifically designed for use with a UICC, (e.g., standardized over-the-air (OTA) messages). In accordance with one embodiment, both protocols that are specifically designed for end-user communication over the Internet, such as hyper text transfer protocol (HTTP), may be used, but also protocols which are not specifically designed for such uses but rather other uses such as communication between machines that does not require human user interactions, such as OMA-DM or TR-069, may also be used.

The protocol or suite of protocols that ensure security of the application downloading process used by the UICC provide the security-related functions of authenticity, confidentiality, and data integrity.

The UICC 120 supports cryptographic procedures whereby it can authenticate itself to the remote server, and vice versa. This may be enacted immediately prior to the downloading of security-sensitive data to the UICC 120. The authentication of the UICC 120 to the remote download server may require reference to an authority which may provide the service of attesting to the validity and security status of the UICC 120, as a pre-requisite to the remote server deciding to allow the downloading of the required applications to the UICC 120. Such attestation may involve authentication of some “bootstrapping” credentials that may be placed on the UICC 120 during its manufacture, but which are un-related to any credentials that are required for operational network access. Conventionally, the bootstrapping credentials include a “shared” secret cryptographic key that is known both to the UICC issuer and to the UICC 120, and the provisioning service would have to request an attestation from the UICC issuer. In accordance with one embodiment, the bootstrapping credentials may be in the form of a public key which is provided by a third-party authority which provides the attestation service and which is known only to the UICC 120 and is part of a public-private key pair. This allows the remote provisioning service to obtain an attestation of the UICC 120 without referring back to the UICC issuer.

The UICC 120 also supports confidentiality in order to prevent an unauthorized party from discovering the contents of a message that is sent to the UICC 120 and, where permitted by regulatory environments, that is sent from the UICC 120. The confidentiality measures may be applied to all of the message or only to sensitive parts of the message. The UICC 120 is capable of decrypting incoming messages and, to the extent permitted by regulatory frameworks, of encrypting outgoing messages.

The UICC 120 also supports data integrity check in order to prevent accidental or intended modification of a message to or from the UICC 120. Cryptographic techniques may be applied to the contents of messages that are sent by the remote server and messages that are generated by the UICC 120. The UICC 120 performs an integrity check of the downloaded application packages upon download. An integrity measurement may be performed on the downloaded package, (e.g., using cryptographic digests), and that the measurement results are compared with reference values obtained from a trustworthy entity, such as the UICC issuer. The reference values may be pre-installed or obtained by a secure communication protocol. The UICC 120 may then follow policies on allowing integrity measurement, installation and execution of the downloaded packages. An external entity may then assume that the UICC 120 operates only trusted application functions.

The UICC 120 is able to extract security-sensitive objects from the downloaded messages and to place them in secure locations on the UICC 120. For the most sensitive objects, (e.g., encryption keys that are used in the process of securely accessing networks and subsystems), the UICC 120 may be required to place them in such locations that are not discoverable by any entity other than the UICC operating system and such that their contents are not discoverable by any entity other than the applications or operating system functions in the UICC 120 that are authorized to do so.

The UICC 120 retrieves an application from the downloaded package, and executes all required cryptographic operations. The UICC 120 recognizes all components of the application and correctly installs those components, where required, in the appropriate security domains. The UICC 120 then places persistent cryptographic keys and other sensitive objects in their required locations and prevents subsequent unauthorized access to them.

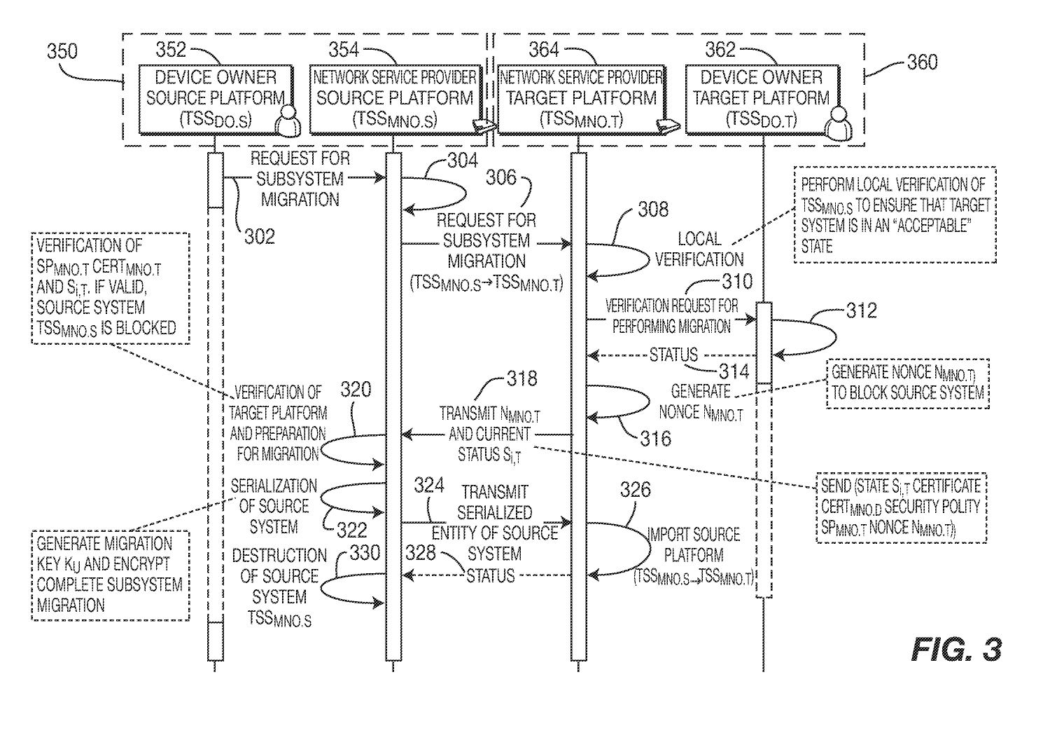

Since the UICC 120 is hosting applications which may be downloaded into the UICC 120, there may be certain situations that require migration of the downloaded application from one UICC to another. As an example, FIG. 3 shows an example procedure 300 for migration of SIM credentials and its execution environment from one UICC to another. The procedure 300 is performed between a source UICC 350 and a target UICC 360. The source UICC 350 includes a trusted subsystem for DO (TSS_{DO.S} 352), and a trusted subsystem for MNO (TSS_{MNO.S} 354) in addition to the TSS for the UICC issuer (not shown). The target UICC 360 includes a trusted subsystem for DO (TSS_{DO.T} 362) and a trusted subsystem for MNO (TSS_{MNO.T} 364) in addition to the TSS for the UICC issuer (not shown). In this example, all security-sensitive data is migrated from the TSS_{MNO.S} 354 to the TSS_{MNO.T} 364.

The device owner starts the migration service of the TSS_{MNO.S} 354. The TSS_{DO.S} 352 sends a request for migration of the subsystem to the TSS_{MNO.S} 354 (step 302). The TSS_{MNO.S} 354 checks on whether the service level of the user and contractual relationship with the target MNO allow the migration (step 304). If it is allowed, the TSS_{MNO.S} 354 sends a request for migration of the subsystem to the TSS_{MNO.T} 364 (step 306). The TSS_{MNO.T} 364 then performs a local verification of the TSS_{MNO.S} 354 to ensure that the target platform is in an acceptable state (step 308). The TSS_{MNO.T} 364 then sends a verification request for performing migration to the TSS_{DO.T} 362 (step 310). The TSS_{DO.T} 362 performs a confirmation (step 312). Upon successful verification, the TSS_{DO.T} 362 sends a status message to the TSS_{MNO.T} 364 (step 314). The TSS_{MNO.T} 364 then generates a NONCE N_{MNO.T} (step 316). The TSS_{MNO.T} 364 sends N_{MNO.T} and current status S_{i,T}, and the like to the TSS_{MNO.S} 354 (step 318). The TSS_{MNO.S} 354 then performs a verification of the platform and prepares it for migration (step 320). Upon successful verification, the TSS_{MNO.S} 354 performs a serialization of the source platform (step 322). The TSS_{MNO.S} 354 then sends a message containing a serialized entity of the source platform to the TSS_{MNO.T} 364 (step 324). The TSS_{MNO.T} 364 imports the source subsystem (step 326). The TSS_{MNO.T} 364 then sends a status message to the TSS_{MNO.S} 354 (step 328). The TSS_{MNO.S} 354 then deletes all security-sensitive data or renders them permanently unusable (step 330).

The UICC 120 supports all functions required to implement secure channels between the UICC 120 and a UICC-hosting device (i.e., WTRU or ME). Such a secure channel may be implemented by a shared-key establishment process such as the 3GPP “local key” establishment process specified in the 3GPP specification TS 33.110, or such as a key that is shared using a Diffie-Hellman algorithm and key-exchange protocols such as the Internet Key Exchange (IKE) version 2 protocol. A local key (Ks_local) derived in this way may act as a platform-level key or key-derivation secret.

Additionally, the UICC 120 may also support multiple secure channels each of which corresponds to each of the isolated application-level domains of the UICC 120 and is intended to secure the channel between each of the isolated domains of the UICC 120 and the UICC-hosting device.

Neither the owner nor any application running in a domain of the UICC 120 is able to eavesdrop on or decipher a secure channel between another domain of the UICC 120 and the UICC-hosting device. Furthermore, the communications between each of the secure domains or applications which run on the UICC 120 may also be secured. No application running in a domain of the UICC 120 may be able to eavesdrop on or decipher a secure channel between any other two domains of the UICC 120.

Although features and elements are described above in particular combinations, each feature or element can be used alone without the other features and elements or in various combinations with or without other features and elements. The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) or Ultra Wide Band (UWB) module.

What is claimed is:

1. A wireless transmit/receive unit (WTRU) comprising:
a mobile equipment (ME) configured to perform wireless communication; and
a universal integrated circuit card (UICC) configured to perform security functionalities, the UICC supporting multiple isolated domains including:
a UICC issuer's domain configured to control creation and deletion of other domains and define and enforce security rules for authorizing third parties to have an access to the domains;
a user's domain owned by a user of a UICC-hosting device; and
at least one remote owner's domain owned by a remote owner, wherein the remote owner stores and executes an application on the UICC under a control of the UICC issuer's domain.

2. The WTRU of claim 1 wherein the UICC is configured to verify integrity of operating system functions and of applications stored on the UICC.

3. The WTRU of claim 2 wherein the UICC is configured to verity the integrity of the operating system functions every time the UICC is reset or powered up.

4. The WTRU of claim 2 wherein the UICC is configured to verity the integrity of the applications when a system-level integrity check is performed or when an application in a security domain is selected for use.

5. The WTRU of claim 2 wherein the UICC is configured to perform an integrity check of a downloaded application package upon receipt.

6. The WTRU of claim 1 wherein the UICC includes an application management entity, the application management entity being configured to manage a downloading process, manage installation, updating and deletion of applications, move applications though their lifecycle stages according to instructions from an authorized external entity or from a function within the UICC, or maintain a registry of applications and their current lifecycle stages.

7. The WTRU of claim 1 wherein the UICC is configured to respond to a query from a remote entity regarding presence and lifecycle status of applications.

8. The WTRU of claim 1 wherein the UICC is configured to control an access to information regarding applications according to security policies stored within the UICC.

9. The WTRU of claim 1 wherein the UICC is configured to control a lifecycle status of downloaded applications.

10. The WTRU of claim 1 wherein the UICC is configured to enable an authorized party to remotely discover existence and lifecycle status of applications on the UICC.

11. The WTRU of claim 1 wherein the UICC includes an application for exchange of credentials so that a remote stakeholder verifies a state of the UICC and sets up credentials in the UICC in preparation for provisioning of a stakeholder application.

12. The WTRU of claim 1 wherein the UICC is configured to download application including security-sensitive objects including at least one of encryption keys, algorithm customization parameters, user identities, executable encryption algorithms, executable commands and responses, file systems, or security policies.

13. The WTRU of claim 1 wherein the UICC is configured to support migration of an application to another UICC.

14. The WTRU of claim 1 wherein the UICC is configured to support a function required to implement a secure channel between the UICC and a UICC-hosting device.

15. The WTRU of claim 14 wherein the UICC is configured to support multiple secure channels each of which corresponds to each of the isolated domains of the UICC to secure a channel between each of the isolated domains of the UICC and the UICC-hosting device.

16. A universal integrated circuit card (UICC) having a virtual subscriber identity module (SIM) functionality, the UICC comprising:
a UICC issuer's domain configured to control creation and deletion of other domains and define and enforce security rules for authorizing third parties to have an access to the domains;
a user's domain owned by a user of a UICC-hosting device; and
at least one remote owner's domain owned by a remote owner, wherein the remote owner stores and executes an application on the UICC under a control of the UICC issuer's domain.

17. The UICC of claim 16 further comprising an entity to verify integrity of operating system and applications stored on the UICC.

18. The UICC of claim 16 further comprising an entity to control a lifecycle status of downloaded applications.

19. The UICC of claim 16 further comprising an entity to enable an authorized party to remotely discover existence and lifecycle status of applications on the UICC.

20. The UICC of claim 16 further comprising an entity configured to exchange credentials so that a remote stakeholder verifies a state of the UICC and sets up credentials in the UICC in preparation for provisioning of a stakeholder application.

21. The UICC of claim 16 further comprising a plurality of secure channels between each of the domains and the UICC-hosting device.
